(19) United States
(12) Patent Application Publication
(10) Pub. No.: US 2026/0071544 A1
(43) Pub. Date: Mar. 12, 2026

(54) EARLY WARNING AND EMERGENCY DEVICE FOR SUDDEN STRESS CHANGE IN SURROUNDING ROCK AND METHOD OF USE

(71) Applicant: ZHALAINUR COAL INDUSTRY LIMITED LIABILITY COMPANY, Manzhouli (CN)

(72) Inventors: Jinliang ZHANG, Manzhouli (CN); Qinghai LI, Qingdao (CN); Shouqing YAN, Manzhouli (CN); Luchao MA, Qingdao (CN); Lin LI, Manzhouli (CN); Zhe LI, Manzhouli (CN); Peijun ZHOU, Manzhouli (CN); Guohui WANG, Manzhouli (CN); Yu ZHAO, Manzhouli (CN); Lei HOU, Qingdao (CN); Jinsheng ZHOU, Qingdao (CN); Qinghan SUN, Qingdao (CN)

(21) Appl. No.: 19/255,288

(22) Filed: Jun. 30, 2025

(30) Foreign Application Priority Data
Sep. 11, 2024 (CN) 202411269787.1

(51) Int. Cl. E21F 17/18; E21C 39/00; G01L 1/22

(52) U.S. Cl. CPC E21F 17/18; E21C 39/00; G01L 1/2231

(57) ABSTRACT

Provided are an early warning and emergency device for a sudden stress change in surrounding rock and a method of use, which relates to the technical field of underground mining. The device includes a front shell, a rotating body, a rear shell, a driving device, a stress monitoring unit, an acoustic and optical early warning unit, a high-pressure jet mechanism, and a data analysis controller. By using the device of the present disclosure, a cloud map of sudden stress changes in surrounding rock can be formed in real time, timely monitoring can be carried out in a case where the stress in the surrounding rock undergoes a high-intensity sudden change, the self-positioning temporary patrol robot is mobilized to perform temporary support for the sudden stress change point of the surrounding rock and timely transmit a sudden stress change early warning signal to remind nearby workers to evacuate in time.

### CROSS-REFERENCE TO RELATED APPLICATIONS

This application claims priority to Chinese Application No. CN202411269787.1, filed on Sep. 11, 2024, entitled “EARLY WARNING AND EMERGENCY DEVICE FOR SUDDEN STRESS CHANGE IN SURROUNDING ROCK AND METHOD OF USE”. These contents are hereby incorporated by reference.

### TECHNICAL FIELD

The present disclosure relates to the technical field of underground mining, and specifically to an early warning and emergency device for a sudden stress change in surrounding rock and a method of use.

### BACKGROUND

In coal mining, the original rock stress field of the ore body is disturbed, destroying the original stress equilibrium state, and the internal stress of the ore body changes to regain the equilibrium state. However, when the stress exceeds the maximum strength that the ore body can withstand, mine pressure will appear, and large-scale mine dynamics phenomena such as rock bursts and roof collapses can even be brought.

In particular, with the continuous increase in the depth and intensity of coal mining, deep mines are very prone to dynamic disasters such as rock bursts, resulting in serious equipment damage and casualties, etc. Since the deep coal rock mass is in a surrounding rock environment of “three highs and one disturbance”, the surrounding rock structure will be subjected to greater stress upon the excavation of the tunnel and working face, and areas of abnormally increased stress to varying degrees can appear within the range of its supporting pressure. These areas of abnormally increased stress are the main areas where dynamic disasters such as rock bursts occur. Existing technologies lack effective monitoring and early warning means for the interior of the areas of abnormally increased stress. Therefore, for deep mines, especially tunnels with impact hazards, it is necessary to use certain monitoring equipment and instruments to monitor and early warn the surrounding rock of the tunnels to ensure the safety of underground construction workers to the greatest extent.

### SUMMARY

In order to solve the above deficiencies in the prior art, the present disclosure provides an early warning and emergency device for a sudden stress change in surrounding rock, with the specific technical solution as follows:

An early warning and emergency device for a sudden stress change in surrounding rock, including a front shell, a rotating body, a rear shell, a driving device, a stress monitoring unit, an acoustic and optical early warning unit, a high-pressure jet mechanism, and a data analysis controller, where the front shell and the rear shell are both of a tubular structure, the front shell is located in front of the rear shell, the front shell and the rear shell have the same outer diameter and are arranged coaxially, the front shell has a closed front end, and its rear end is connected to a front end of the rear shell through the rotating body.

The interiors of tube walls of the front shell and the rear shell are both annular cavities with closed ends, a stress monitoring unit is provided inside each of the annular cavities of the front shell and the rear shell. There are a plurality of water guide grooves on an outer side wall of the rear shell, the data analysis controller is disposed on the inner side of the rear shell and is communicatively connected to the stress monitoring units. A positioning module and a wireless communication module are also provided inside the rear shell, the data analysis controller is connected to a downhole gateway through the wireless communication module.

The acoustic and optical early warning unit is disposed at the rear end of the rear shell and is communicatively connected to the data analysis controller.

A front end of the rotating body is located inside the front shell and is rotationally sealed with the front shell, and a rear end thereof is located inside the rear shell and is rotationally sealed with the rear shell.

The driving device is disposed inside the front shell, and includes a servo motor and a gear mechanism. An output end of the servo motor drives, through the gear mechanism, the rotating body to rotate relative to the front shell 1 and the rear shell.

The high-pressure jet mechanism includes a water supply pipe I, a rotary joint, a water supply pipe II, a high-pressure nozzle, and a direction adjustment assembly. The water supply pipe I is located on an inner side of the rear shell. A front end of the water supply pipe I, through the rotary joint, is connected to and communicated with one end of the water supply pipe II arranged on the rotating body, and a rear end thereof passes through the rear shell and can be connected to a high-pressure water supply device.

The high-pressure nozzle is mounted on the water supply pipe II, and the direction adjustment assembly is arranged on the rotating body. The direction of the high-pressure nozzle is controlled by driving the water supply pipe II to rotate around the rotary joint.

Further, the front shell includes a first outer tube body and a first inner tube body. The first inner tube body is located on an inner side of the first outer tube body and is arranged coaxially therewith. A rear end of the first outer tube body is connected to a rear end of the first inner tube body through a first annular rubber sheet. The first annular rubber sheet seals the annular cavity inside the front shell.

There are a plurality of first springs evenly arranged in a ring shape between the first inner tube body and the first outer tube body. Each group of first springs includes a plurality of first springs arranged at intervals along an axial direction of the first inner tube body. Each first spring is arranged along a normal direction of a cross section of the first inner tube body.

Further, the rear shell includes a second outer tube body and a second inner tube body. The second outer tube body and the second inner tube body are both straight circular tubes. The second inner tube body is located on an inner side of the second outer tube body and is arranged coaxially therewith.

Front and rear ends of the second outer tube body are connected to corresponding ends of the second inner tube body through a second annular rubber sheet, respectively. The second annular rubber sheet seals the annular cavity inside the rear shell.

There are a plurality of second springs evenly arranged in a ring shape between the second inner tube body and the second outer tube body. Each group of second springs includes a plurality of second springs arranged at intervals along an axial direction of the second inner tube body. Each second spring is arranged along a normal direction of a cross section of the second inner tube body.

Further, each of the stress monitoring units includes a plurality of groups of strain gauges arranged at intervals in sequence along the axial direction of the front shell. Each group of strain gauges includes twelve strain gauges evenly arranged in a ring shape on a circumferential outer wall of the first inner tube body or the second inner tube body. All the strain gauges are electrically connected to the data analysis controller.

A circumferential inner wall of the first outer tube body is provided with pressure-guiding columns whose number is equal to and positions correspond to that of the strain gauges on the first inner tube body, and a circumferential inner wall of the second outer tube body is provided with pressure-guiding columns whose number is equal to and positions correspond to that of the strain gauges on the second inner tube body. The pressure-guiding columns are of a conical structure, with their pointed ends directly opposite to the strain gauges.

Further, the rotating body is of a cylindrical structure with a cavity, and upper and lower ends of the rotating body are provided with an upper end shaft and a lower end shaft that are coaxial therewith, respectively.

The rear end of the front shell is provided with a first end ring, the front end of the rear shell is provided with a second end ring, and the rear end of the rear shell is provided with a rear end cover. The upper end shaft passes through the center of the first end ring and is rotationally connected to an inner wall of the front shell, and an outer wall of the upper end shaft is rotationally sealed with the first end ring. The lower end shaft passes through the center of the second end ring and is rotationally connected to an inner wall of the rear shell, and an outer wall of the lower end shaft is rotationally sealed with the second end ring.

Further, the gear mechanism includes a driving gear and a driven gear. The driven gear is fixedly mounted on the lower end shaft. The servo motor is mounted inside the rear shell, and is powered by a battery provided in the rear shell. A signal end of the servo motor is communicatively connected to the data analysis controller.

The driven gear is arranged on an output shaft of the servo motor, and meshes with the driving gear to drive the rotating body to rotate relative to the front shell and the rear shell. Further, a vertical groove is defined in a circumferential side wall of the rotating body, and the vertical groove is communicated with the cavity inside the rotating body. The water supply pipe I is embedded in the rotating body and is arranged coaxially therewith. A front end of the water supply pipe I is connected to and communicated with an inlet of the rotary joint, and a rear end thereof passes through the rear end cover and extends to the outside of the rear shell. The water supply pipe I is configured with a solenoid valve which is communicatively connected to the data analysis controller.

The water supply pipe II is located in the vertical groove, and one end of the water supply pipe II is connected to and communicated with an outlet of the rotary joint. The high-pressure nozzle is located outside the rotating body and is mounted at the other end of the water supply pipe II. The high-pressure nozzle and the water supply pipe II can rotate around the rotary joint.

The direction adjustment assembly includes an electric telescopic rod and two articulated seats. The electric telescopic rod is located above the water supply pipe II. The water supply pipe II is connected to an inner wall of the cavity of the rotating body through the electric telescopic rod. The electric telescopic rod drives the high-pressure nozzle and the water supply pipe II to swing up and down.

Further, the data analysis controller is embedded with FLAC 3D numerical simulation software and matlab data processing modules, and the stress monitoring units and the positioning module are communicatively connected to the data analysis controller, respectively.

The data analysis controller rapidly processes the electrical signals transmitted by the stress monitoring units to generate a cloud map of sudden stress changes in surrounding rock, achieving full tunnel coverage of the cloud map of sudden stress changes. In a case where a sudden stress change in surrounding rock occurs somewhere in the tunnel, a sudden stress change point can be instantly determined based on the cloud map of the sudden stress change in the tunnel and the positioning module.

Another objective of the present disclosure is to provide a method of using an early warning and emergency device for a sudden stress change in surrounding rock.

A method of using an early warning and emergency device for a sudden stress change in surrounding rock adopts the above early warning and emergency device for a sudden stress change in surrounding rock. The method of use comprises the following steps:
S1. Determine sudden stress change early warning thresholds for surrounding rock based on the analysis of tunnel field monitoring data and laboratory experimental data, the early warning thresholds including an early warning threshold and an early warning threshold, and import the sudden stress change early warning thresholds into a data analysis controller. Specifically, the surrounding rock refers to the coal-rock mass.
S2. Determine a transport tunnel section that is greatly affected by mining stress and has a large number of workers, arrange a self-positioning temporary patrol robot in the transport tunnel section, determine installation points of early warning and emergency devices for a sudden stress change in surrounding rock on a rock wall of the transport tunnel section, drill holes at the installation points on the rock wall, and clean the inside of boreholes.

All the installation points are arranged in a square array on the rock wall. The horizontal distance between any two adjacent installation points is 3 m to 5 m, and the vertical distance between any two adjacent installation points is 1 m to 1.5 m.
S3. Adjust the relative positions of the front shell and the rear shell so that the stress monitoring unit in the front shell corresponds to the stress monitoring unit in the rear shell, and apply anchoring glue on the outer walls of the front shell and the rear shell, avoiding the water guide grooves outside the rear shell.

Afterwards, the early warning and emergency devices for a sudden stress change in surrounding rock are sent into the boreholes, the front shells and rear shells are fixed to the rock walls inside the boreholes with anchoring glue, and the ends of each water supply pipe I are connected to the high-pressure water supply device.
S4. Number and zero each early warning and emergency device for a sudden stress change in surrounding rock, and establish communicative connection with an underground gateway.

The stress monitoring units are activated, a sudden stress change in the surrounding rock is monitored through the strain gauges and the ground sound sensor, and the sudden stress change signal is converted into an electrical signal and transmitted to the data analysis controller in real time.

The data analysis controller processes the received electrical signals in real time through the internally embedded FLAC 3D numerical simulation software and matlab data processing modules to generate a real-time cloud map of sudden stress changes of the entire tunnel.
S5. The data analysis controller compares and analyzes a sudden stress change value with the early warning thresholds in real time, and the wireless communication module transmits the comparison and analysis results to the underground gateway in real time.

In a case where the sudden stress change value is less than the early warning threshold 1, the high-pressure jet mechanism, the acoustic and optical early warning unit and the self-positioning temporary patrol robot will not respond.

In a case where the sudden stress change value is greater than or equal to the early warning threshold and less than the early warning threshold, the positioning module locates the sudden stress change point, the early warning and emergency device for a sudden stress change in surrounding rock near the sudden stress change point responds, and the high-pressure nozzle hydraulically perforates, depressurizes and softens the sudden stress change point; the wireless communication module sends sudden stress change point information and inspection information to a ground dispatching department through the underground gateway to pre-crack and depressurize the rock mass near the sudden stress change point, and meanwhile, the self-positioning temporary patrol robot responds to provide temporary support for the sudden stress change point.

In a case where the early warning threshold is less than or equal to the sudden stress change value, an acoustic and optical early warning device responds to remind nearby workers to evacuate quickly, the high-pressure nozzle continues to hydraulically perforate, depressurize and soften the sudden stress change point, and the wireless communication module sends the sudden stress change point information and rescue information to the ground dispatching department through the underground gateway.

Further, the self-positioning temporary patrol robot includes a frame, crawler walking mechanisms, an engine, a lifting bracket, a top plate, and a self-positioning control unit. There are two crawler walking mechanisms symmetrically arranged on both sides of the frame.

The engine is arranged on the frame to drive the crawler walking mechanisms to walk. The top plate is located above the frame, and the bottom of the top plate is connected to the top of the frame through the lifting bracket. The self-positioning control unit is arranged at the front of the frame to control the self-positioning temporary patrol robot to patrol the line. The beneficial effects of the present disclosure are as follows:

By using the early warning and emergency device for a sudden stress change in surrounding rock of the present disclosure, a cloud map of sudden stress changes in surrounding rock of the entire tunnel can be formed in real time in an underground tunnel, timely monitoring, early warning and positioning can be carried out in a case where the stress in the surrounding rock undergoes a high-intensity sudden change, and the rock mass of the sudden stress change portion can be hydraulically perforated, depressurized and softened by means of directional high-pressure water jet perforation and softening, which can delay and weaken the hazards caused by sudden stress changes and rock bursts; meanwhile, the self-positioning temporary patrol robot is mobilized to perform temporary support for the sudden stress change point of the surrounding rock and timely transmit a sudden stress change early warning signal to send accurate location information and distress signals to the ground dispatching department, so as to launch rescue in the first time; meanwhile, the acoustic and optical early warning device is activated to emit alarm sound and alarm light to remind nearby workers to evacuate in time, which can minimize the casualties and property losses caused by high-intensity sudden stress changes in the surrounding rock and rock bursts.

### BRIEF DESCRIPTION OF THE DRAWINGS

FIG. 1 is a schematic structural diagram of an early warning and emergency device for a sudden stress change in surrounding rock according to the present disclosure.

FIG. 2 is a cross-sectional view of a rear shell and related portions according to the present disclosure.

FIG. 3 is a cross-sectional view of a front shell and related portions according to the present disclosure.

FIG. 4 is a diagram of a state of use of an early warning and emergency device for a sudden stress change in surrounding rock according to the present disclosure.

FIG. 5 is a schematic structural diagram of a self-positioning temporary patrol robot according to the present disclosure.

As shown in the figures:
1. front shell; 11. first outer tube body; 12. first inner tube body; 13. first annular rubber sheet; 14. first spring; 15. first end ring; 16. first O-ring; 2. rotating body; 21. upper end shaft; 22. lower end shaft; 23. vertical groove; 3. rear shell; 31. second outer tube body; 311. water guide groove; 32. second inner tube body; 33. second annular rubber sheet; 34. second spring; 35. second end ring; 36. rear end cover; 37. second O-ring; 4. data analysis controller; 51. strain gauge; 52. pressure-guiding column; 61. servo motor; 62. driving gear; 63. driven gear; 71. water supply pipe I; 711. solenoid valve; 72. rotary joint; 73. water supply pipe II; 74. high-pressure nozzle; 75. electric telescopic rod; 81. positioning module; 82. wireless communication module; 83. buzzer; 84. alarm light; 9. battery; 10. borehole; 101. frame; 102. crawler walking mechanism; 103. engine; 104. lifting bracket; 105. top plate; 106. self-positioning control unit.

### DETAILED DESCRIPTION OF THE EMBODIMENT

The present invention will be further described with reference to the drawings and preferred embodiments. It should be understood that these embodiments are only used to illustrate the present invention, but the present invention is not limited thereto.

### Embodiment 1

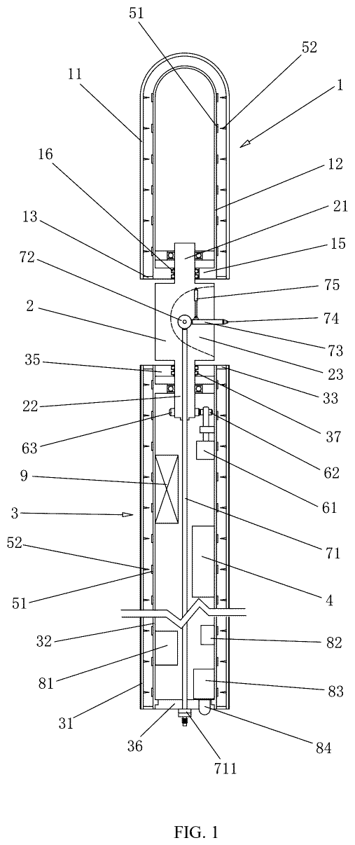

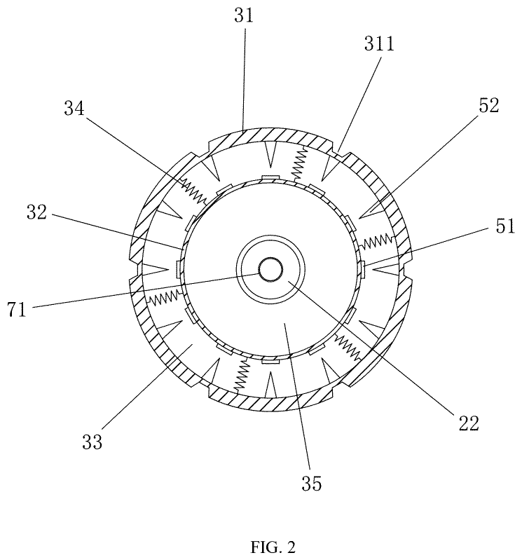

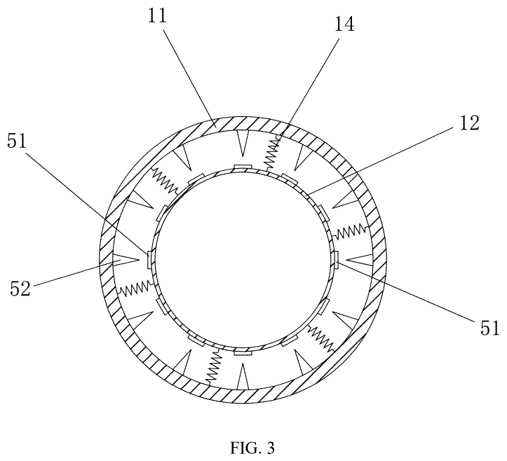

As shown in FIG. 1-FIG. 3, an early warning and emergency device for a sudden stress change in surrounding rock is provided, which includes a front shell 1, a rotating body 2, a rear shell 3, a driving device, a stress monitoring unit, an acoustic and optical early warning unit, a high-pressure jet mechanism, and a data analysis controller 4, where the front shell 1 and the rear shell 3 are both of a tubular structure, the front shell 1 is located in front of the rear shell 3, the front shell 1 and the rear shell 3 have the same outer diameter and are arranged coaxially, the front shell 1 has a closed front end, and its rear end is connected to a front end of the rear shell 3 through the rotating body 2, and the interiors of tube walls of the front shell 1 and the rear shell 3 are both annular cavities with closed ends.

Specifically, the front shell 1 includes a first outer tube body 11 and a first inner tube body 12. The first outer tube body 11 and the first inner tube body 12 are both straight circular tubes with closed front ends. The first inner tube body 12 is located on an inner side of the first outer tube body 11 and is arranged coaxially therewith. A rear end of the first outer tube body 11 is connected to a rear end of the first inner tube body 12 through a first annular rubber sheet 13. The first annular rubber sheet 13 seals the annular cavity inside the front shell 1. An outer edge of the first annular rubber sheet 13 is connected to the rear end of the first outer tube body 11 as a whole, and an inner edge of the first annular rubber sheet 13 is connected to the rear end of the first inner tube body 12 as a whole, preventing pressurized water outside the first outer tube body 11 from entering its interior.

There are six groups of first springs 14 evenly arranged in a ring shape between the first inner tube body 12 and the first outer tube body 11. Each group of first springs 14 includes a plurality of first springs 14 arranged at intervals along an axial direction of the first inner tube body 12. Each first spring 14 is arranged along a normal direction of a cross section of the first inner tube body 12, and one end of the first spring 14 is fixedly connected to an outer wall of the first outer tube body 11. Each first spring 14 is in a compressed state and keeps the first inner tube body 12 and the first outer tube body 11 in a coaxial state. The first annular rubber sheet 13 encloses all the first springs 14 in the annular cavity between the first inner tube body 12 and the first outer tube body 11.

The rear shell 3 includes a second outer tube body 31 and a second inner tube body 32. The second outer tube body 31 and the second inner tube body 32 are both straight circular tubes. The second inner tube body 32 is located on an inner side of the second outer tube body 31 and is arranged coaxially therewith. The second outer tube body 31 and the first outer tube body 11 have the same specification, and the second inner tube body 32 and the first inner tube body 12 have the same specification. There are six water guide grooves 311 on an outer side wall of the second outer tube body 31. The six water guide grooves 311 are evenly distributed on a circle with the axis of the second outer tube body 31 as the center. Front and rear ends of the water guide grooves 311 extend to front and rear end surfaces of the second outer tube body 31, respectively, for the high-pressure water flow ejected from a high-pressure nozzle 74 to jet the surrounding rock and then be discharged from the water guide grooves 311.

Front and rear ends of the second outer tube body 31 are connected to corresponding ends of the second inner tube body 32 through a second annular rubber sheet 33, respectively. The second annular rubber sheet 33 seals the annular cavity inside the rear shell 3. An outer edge of the second annular rubber sheet 33 is connected to the end of the second outer tube body 31 as a whole, and an inner edge of the second annular rubber sheet 33 is connected to the end of the second inner tube body 32 as a whole. The second annular rubber sheet 33 seals the annular cavity between the second outer tube body 31 and the second inner tube body 32, preventing pressurized water outside the second outer tube body 31 from entering its interior.

There are six groups of second springs 34 evenly arranged in a ring shape between the second inner tube body 32 and the second outer tube body 31. Each group of second springs 34 includes a plurality of second springs 34 arranged at intervals along an axial direction of the second inner tube body 32. Each second spring 34 is arranged along a normal direction of a cross section of the second inner tube body 32, and one end of the second spring 34 is fixedly connected to an outer wall of the second outer tube body 31. Each second spring 34 is in a compressed state and keeps the second inner tube body 32 and the second outer tube body 31 in a coaxial state. The second annular rubber sheet 33 encloses all the second springs 34 in the annular cavity between the second inner tube body 32 and the second outer tube body 31.

A stress monitoring unit is provided inside each of the annular cavities of the front shell 1 and the rear shell 3. Each of the stress monitoring units includes a plurality of groups of strain gauges 51 arranged at intervals in sequence along the axial direction of the front shell 1. Each group of strain gauges 51 includes twelve strain gauges 51 evenly arranged in a ring shape on a circumferential outer wall of the first inner tube body 12 or the second inner tube body 32. All the strain gauges 51 are electrically connected to the data analysis controller 4, and transmit electrical signals to the data analysis controller 4 in real time.

Specifically, a circumferential inner wall of the first outer tube body 11 is provided with pressure-guiding columns 52 whose number is equal to and positions correspond to that of the strain gauges 51 on the first inner tube body 12, and a circumferential inner wall of the second outer tube body 31 is provided with pressure-guiding columns 52 whose number is equal to and positions correspond to that of the strain gauges 51 on the second inner tube body 32. The pressure-guiding columns 52 are of a conical structure, with their pointed ends directly opposite to the strain gauges 51.

A front end of the rotating body 2 is located inside the front shell 1 and is rotationally sealed with the front shell 1, and a rear end thereof is located inside the rear shell 3 and is rotationally sealed with the rear shell 3. Specifically, the rotating body 2 is of a cylindrical structure with a cavity, and upper and lower ends of the rotating body 2 are provided with an upper end shaft 21 and a lower end shaft 22 that are coaxial therewith, respectively. The upper end of the rotating body 2 is rotationally connected to the first inner tube body 12 through the upper end shaft 21, and the lower end of the rotating body 2 is rotationally connected to the second inner tube body 32 through the lower end shaft 22. Upon the installation of the early warning and emergency device for a sudden stress change in surrounding rock in a rock wall of a tunnel, the first outer tube body 11 and the second outer tube body 31 are both anchored in a borehole of the coal rock mass, the first inner tube body 12 keeps coaxial with the first outer tube body 11 under the action of the six groups of first springs 14, and the second inner tube body 32 keeps coaxial with the second outer tube body 31 under the action of the six groups of second springs 34. In this state, the rotating body 2 can achieve a 360° rotation relative to the first inner tube body 12 and the second inner tube body 32.

The rear end of the front shell 1 is provided with a first end ring 15, the front end of the rear shell 3 is provided with a second end ring 35, and the rear end of the rear shell 3 is provided with a rear end cover 36. The upper end shaft 21 passes through the center of the first end ring 15 and is rotationally connected to an inner wall of the front shell 1, and an outer wall of the upper end shaft 21 is rotationally sealed with the first end ring 15. The lower end shaft 22 passes through the center of the second end ring 35 and is rotationally connected to an inner wall of the rear shell 3, and an outer wall of the lower end shaft 22 is rotationally sealed with the second end ring 35. Specifically, two installation grooves arranged at intervals are defined on inner side walls of the first end ring 15 and the second end ring 35, separately, a first O-ring 16 is embedded in the installation groove of the first end ring 15, and a second O-ring 37 is embedded in the installation groove of the second end ring 35, so as to block the high-pressure water flow ejected from the high-pressure nozzle 74 from entering the interiors of the first inner tube body 12 and the second inner tube body 32, avoid damaging electronic components therein, and ensure safe and stable operation of the early warning and emergency device for a sudden stress change in surrounding rock.

The driving device is disposed inside the front shell 1, and includes a servo motor 61 and a gear mechanism. An output end of the servo motor 61 drives, through the gear mechanism, the rotating body 2 to rotate relative to the front shell 1 and the rear shell 3. The gear mechanism includes a driving gear 62 and a driven gear 63. The driven gear 63 is fixedly mounted on the lower end shaft 22. The servo motor 61 is mounted inside the rear shell 3, and is powered by a battery 9 provided in the rear shell 3. A signal end of the servo motor 61 is communicatively connected to the data analysis controller 4. In addition, a terminal is provided on the rear end cover 36 of the rear shell 3. The terminal can be connected to an external power source and supply power to the servo motor 61, serving as a backup in case of insufficient power supply from the battery 9.

The driven gear 63 is arranged on an output shaft of the servo motor 61, and meshes with the driving gear 62 to drive the rotating body 2 to rotate relative to the front shell 1 and the rear shell 3. In case of sudden stress in the surrounding rock, an outer wall of the front shell 1 and/or the rear shell 3 will be squeezed, causing the front shell 1 and/or the rear shell 3 to shift to one side along the direction of the sudden stress. Ends of the pressure-guiding columns 52 are in contact with the strain gauges 51 and act on the strain gauges 51. The stress monitoring units determine the direction of the sudden stress based on a received electrical signal, and determine the position of the sudden stress in combination with a ground sound sensor. Upon the determination, the driving device adjusts the angle according to instructions from the stress monitoring units, so that the high-pressure jet mechanism faces the direction of the sudden stress and sprays high-pressure water to the coal rock mass to perforate, depressurize and soften the coal rock mass, which can delay and weaken the hazards caused by sudden stress changes and rock bursts.

The high-pressure jet mechanism includes a water supply pipe I 71, a rotary joint 72, a water supply pipe II 73, a high-pressure nozzle 74, and a direction adjustment assembly. The water supply pipe I 71 is located on an inner side of the rear shell 3. A front end of the water supply pipe I 71, through the rotary joint 72, is connected to and communicated with one end of the water supply pipe II 73 arranged on the rotating body 2, and a rear end thereof passes through the rear shell 3 and can be connected to a high-pressure water supply device. The high-pressure nozzle 74 is mounted on the water supply pipe II 73, and the direction adjustment assembly is arranged on the rotating body 2. The direction of the high-pressure nozzle 74 is controlled by driving the water supply pipe II 73 to rotate around the rotary joint 72.

A vertical groove is defined in a circumferential side wall of the rotating body 2, and the vertical groove is communicated with the cavity inside the rotating body 2. The water supply pipe I 71 is embedded in the rotating body 2 and is arranged coaxially therewith. A front end of the water supply pipe I 71 is connected to and communicated with an inlet of the rotary joint 72, and a rear end thereof passes through the rear end cover 36 and extends to the outside of the rear shell 3. The water supply pipe I 71 is configured with a solenoid valve which is communicatively connected to the data analysis controller 4.

The water supply pipe II 73 is located in the vertical groove, and one end of the water supply pipe II 73 is connected to and communicated with an outlet of the rotary joint 72. The high-pressure nozzle 74 is located outside the rotating body 2 and is mounted at the other end of the water supply pipe II 73. The high-pressure nozzle 74 and the water supply pipe II 73 can rotate around the rotary joint 72.

The direction adjustment assembly includes an electric telescopic rod 75 and two articulated seats. The electric telescopic rod 75 is located above the water supply pipe II 73. The water supply pipe II 73 is connected to an inner wall of the cavity of the rotating body 2 through the electric telescopic rod 75. The electric telescopic rod 75 drives the high-pressure nozzle 74 and the water supply pipe II 73 to swing up and down. The high-pressure nozzle 74 and the water supply pipe II 73 rotate around the rotary joint 72 within a range of 0° to 140°. A signal end of the electric telescopic rod 75 is communicatively connected to the data analysis controller 4. The data analysis controller 4 controls, through instructions, the water supply pipe II 73 to rotate, so that the high-pressure nozzle 74 faces the direction in which a sudden stress change occurs and jets high-pressure water to perforate, depressurize and soften the coal rock mass.

The data analysis controller 4 is disposed on the inner side of the rear shell 3 and is communicatively connected to the stress monitoring units. A positioning module 81 and a wireless communication module 82 are also provided inside the rear shell 3. The data analysis controller 4 is connected to a downhole gateway through the wireless communication module 82, and a cloud map of sudden stress changes and analysis results generated by the data analysis controller 4 are transmitted through the downhole gateway to a scheduling department above the bottom surface.

The acoustic and optical early warning unit is disposed at the rear end of the rear shell 3, and includes a buzzer 83 and an alarm light 84. The buzzer 83 and the alarm light 84 are communicatively connected to the data analysis controller 4, respectively. In a case where an abnormal state is detected, the data analysis controller 4 controls the buzzer 83 to emit an early warning alarm, and the alarm light 84 starts to flash to warn construction workers near the tunnel and inform them of hazardous areas based on the number and position of the alarm light 84 of each early warning and emergency device for a sudden stress change in surrounding rock.

The data analysis controller 4 is embedded with FLAC 3D numerical simulation software and matlab data processing modules, and the stress monitoring units and the positioning module 81 are communicatively connected to the data analysis controller 4, respectively. The data analysis controller 4 rapidly processes the electrical signals transmitted by the stress monitoring units to generate a cloud map of sudden stress changes in surrounding rock, achieving full tunnel coverage of the cloud map of sudden stress changes. In a case where a sudden stress change in surrounding rock occurs somewhere in the tunnel, a sudden stress change point can be instantly determined based on the cloud map of the sudden stress change in the tunnel and the positioning module 81.

### Example 2

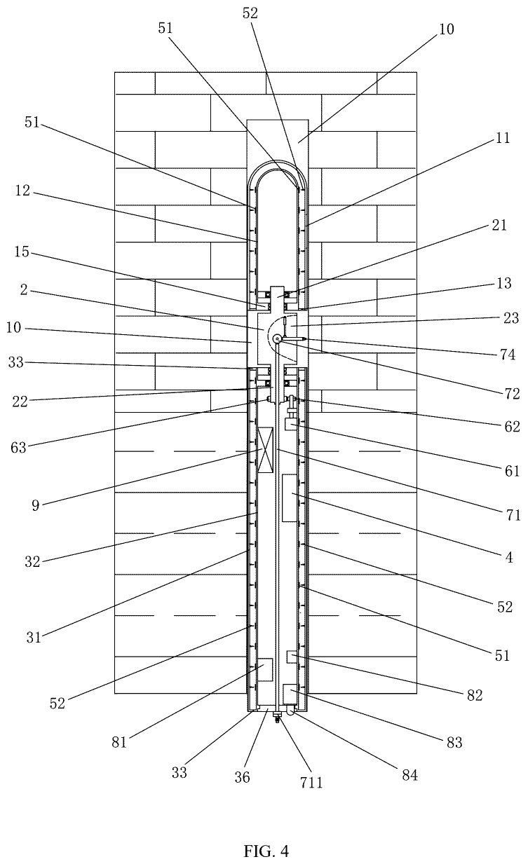

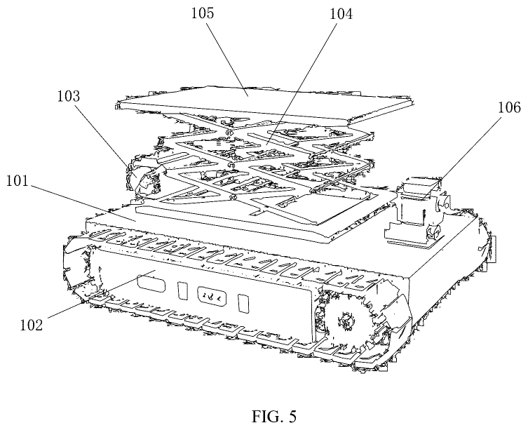

As shown in FIG. 1-5, a method of using an early warning and emergency device for a sudden stress change in surrounding rock adopts the above early warning and emergency device for a sudden stress change in surrounding rock. The method of use comprises the following steps:
S1. Determine sudden stress change early warning thresholds for surrounding rock based on the analysis of tunnel field monitoring data and laboratory experimental data, the early warning thresholds including an early warning threshold 1 and an early warning threshold 2, and import the sudden stress change early warning thresholds into a data analysis controller 4.
S2. Determine a transport tunnel section that is greatly affected by mining stress and has a large number of workers, arrange a self-positioning temporary patrol robot in the transport tunnel section, determine installation points of early warning and emergency devices for a sudden stress change in surrounding rock on a rock wall of the transport tunnel section, drill holes at the installation points on the rock wall, and clean the inside of boreholes 10.

All the installation points are arranged in a square array on the rock wall. The horizontal distance between any two adjacent installation points is 3 m to 5 m, and the vertical distance between any two adjacent installation points is 1 m to 1.5 m.

The self-positioning temporary patrol robot includes a frame 101, crawler walking mechanisms 102, an engine 103, a lifting bracket 104, a top plate 105, and a self-positioning control unit 106. There are two crawler walking mechanisms 102 symmetrically arranged on both sides of the frame 101. The engine 103 is arranged on the frame 101 to drive the crawler walking mechanisms 102 to walk. The top plate 105 is located above the frame 101, and the bottom of the top plate 105 is connected to the top of the frame 101 through the lifting bracket 104. The self-positioning control unit 106 is arranged at the front of the frame 101 to control the self-positioning temporary patrol robot to patrol the line.
S3. Adjust the relative positions of the front shell 1 and the rear shell 3 so that the stress monitoring unit in the front shell 1 corresponds to the stress monitoring unit in the rear shell 3, and apply anchoring glue on the outer walls of the front shell 1 and the rear shell 3, avoiding the water guide grooves outside the rear shell 3.

Afterwards, the early warning and emergency devices for a sudden stress change in surrounding rock are sent into the boreholes, the front shells 1 and rear shells 3 are fixed to the rock walls inside the boreholes with anchoring glue, and the ends of each water supply pipe I 71 are connected to the high-pressure water supply device.
S4. Number and zero each early warning and emergency device for a sudden stress change in surrounding rock, and establish communicative connection with an underground gateway.

The stress monitoring units are activated, a sudden stress change in the surrounding rock is monitored through the strain gauges 51 and the ground sound sensor, and the sudden stress change signal is converted into an electrical signal and transmitted to the data analysis controller 4 in real time.

The data analysis controller 4 processes the received electrical signals in real time through the internally embedded FLAC 3D numerical simulation software and matlab data processing modules to generate a real-time cloud map of sudden stress changes of the entire tunnel.
S5. The data analysis controller 4 compares and analyzes a sudden stress change value with the early warning thresholds in real time, and the wireless communication module 82 transmits the comparison and analysis results to the underground gateway in real time.

In a case where the sudden stress change value is less than the early warning threshold 1, the high-pressure jet mechanism, the acoustic and optical early warning unit and the self-positioning temporary patrol robot will not respond.

In a case where the sudden stress change value is greater than or equal to the early warning threshold 1 and less than the early warning threshold 2, the positioning module 81 locates the sudden stress change point, the early warning and emergency device for a sudden stress change in surrounding rock near the sudden stress change point responds, and the high-pressure nozzle 74 hydraulically perforates, depressurizes and softens the sudden stress change point; the wireless communication module 82 sends sudden stress change point information and inspection information to a ground dispatching department through the underground gateway to pre-crack and depressurize the rock mass near the sudden stress change point, and meanwhile, the self-positioning temporary patrol robot responds to provide temporary support for the sudden stress change point.

In a case where the early warning threshold 2 is less than or equal to the sudden stress change value, an acoustic and optical early warning device responds to remind nearby workers to evacuate quickly, the high-pressure nozzle 74 continues to hydraulically perforate, depressurize and soften the sudden stress change point, and the wireless communication module 82 sends the sudden stress change point information and rescue information to the ground dispatching department through the underground gateway.

In the present invention, the terms “first,” “second,” and “third” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. An early warning and emergency device for a sudden stress change in surrounding rock, comprising a front shell, a rotating body, a rear shell, a driving device, a stress monitoring unit, an acoustic and optical early warning unit, a high-pressure jet mechanism, and a data analysis controller, where the front shell and the rear shell are both of a tubular structure, the front shell is located in front of the rear shell, the front shell and the rear shell have the same outer diameter and are arranged coaxially, the front shell has a closed front end, and its rear end is connected to a front end of the rear shell through the rotating body;
the interiors of tube walls of the front shell and the rear shell are both annular cavities with closed ends, a stress monitoring unit is provided inside each of the annular cavities of the front shell and the rear shell, there are a plurality of water guide grooves on an outer side wall of the rear shell, the data analysis controller is disposed on the inner side of the rear shell and is communicatively connected to the stress monitoring units; a positioning module and a wireless communication module are also provided inside the rear shell, the data analysis controller is connected to a downhole gateway through the wireless communication module;
the acoustic and optical early warning unit is disposed at the rear end of the rear shell and is communicatively connected to the data analysis controller;
a front end of the rotating body is located inside the front shell and is rotationally sealed with the front shell, and a rear end thereof is located inside the rear shell and is rotationally sealed with the rear shell;
the driving device is disposed inside the front shell, and comprises a servo motor and a gear mechanism, an output end of the servo motor drives, through the gear mechanism, the rotating body to rotate relative to the front shell 1 and the rear shell;
the high-pressure jet mechanism comprises a water supply pipe I, a rotary joint, a water supply pipe II, a high-pressure nozzle, and a direction adjustment assembly, the water supply pipe I is located on an inner side of the rear shell, a front end of the water supply pipe I, through the rotary joint, is connected to and communicated with one end of the water supply pipe II arranged on the rotating body, and a rear end thereof passes through the rear shell and can be connected to a high-pressure water supply device;
the high-pressure nozzle is mounted on the water supply pipe II, and the direction adjustment assembly is arranged on the rotating body, the direction of the high-pressure nozzle is controlled by driving the water supply pipe II to rotate around the rotary joint;
the front shell comprises a first outer tube body and a first inner tube body, the first inner tube body is located on an inner side of the first outer tube body and is arranged coaxially therewith; a rear end of the first outer tube body is connected to a rear end of the first inner tube body through a first annular rubber sheet, the first annular rubber sheet seals the annular cavity inside the front shell;
there are a plurality of first springs evenly arranged in a ring shape between the first inner tube body and the first outer tube body, each group of first springs comprises a plurality of first springs arranged at intervals along an axial direction of the first inner tube body, each first spring is arranged along a normal direction of a cross section of the first inner tube body;
the rear shell comprises a second outer tube body and a second inner tube body, the second outer tube body and the second inner tube body are both straight circular tubes, the second inner tube body is located on an inner side of the second outer tube body and is arranged coaxially therewith;
front and rear ends of the second outer tube body are connected to corresponding ends of the second inner tube body through a second annular rubber sheet, respectively; the second annular rubber sheet seals the annular cavity inside the rear shell;
there are a plurality of second springs evenly arranged in a ring shape between the second inner tube body and the second outer tube body, each group of second springs comprises a plurality of second springs arranged at intervals along an axial direction of the second inner tube body, each second spring is arranged along a normal direction of a cross section of the second inner tube body;
each of the stress monitoring units comprises a plurality of groups of strain gauges arranged at intervals in sequence along the axial direction of the front shell, each group of strain gauges comprises twelve strain gauges evenly arranged in a ring shape on a circumferential outer wall of the first inner tube body or the second inner tube body, all the strain gauges are electrically connected to the data analysis controller;
a circumferential inner wall of the first outer tube body is provided with pressure-guiding columns whose number is equal to and positions correspond to that of the strain gauges on the first inner tube body, and a circumferential inner wall of the second outer tube body is provided with pressure-guiding columns whose number is equal to and positions correspond to that of the strain gauges on the second inner tube body, the pressure-guiding columns are of a conical structure, with their pointed ends directly opposite to the strain gauges.

2. The early warning and emergency device for a sudden stress change in surrounding rock according to claim 1, wherein the rotating body is of a cylindrical structure with a cavity, and upper and lower ends of the rotating body are provided with an upper end shaft and a lower end shaft that are coaxial therewith, respectively;
the rear end of the front shell is provided with a first end ring, the front end of the rear shell is provided with a second end ring, and the rear end of the rear shell is provided with a rear end cover; the upper end shaft passes through the center of the first end ring and is rotationally connected to an inner wall of the front shell, and an outer wall of the upper end shaft is rotationally sealed with the first end ring; the lower end shaft passes through the center of the second end ring and is rotationally connected to an inner wall of the rear shell, and an outer wall of the lower end shaft is rotationally sealed with the second end ring.

3. The early warning and emergency device for a sudden stress change in surrounding rock according to claim 2, wherein the gear mechanism comprises a driving gear and a driven gear, the driven gear is fixedly mounted on the lower end shaft, the servo motor is mounted inside the rear shell, and is powered by a battery provided in the rear shell, a signal end of the servo motor is communicatively connected to the data analysis controller;
the driven gear is arranged on an output shaft of the servo motor, and meshes with the driving gear to drive the rotating body to rotate relative to the front shell and the rear shell.

4. The early warning and emergency device for a sudden stress change in surrounding rock according to claim 2, wherein a vertical groove is defined in a circumferential side wall of the rotating body, and the vertical groove is communicated with the cavity inside the rotating body, the water supply pipe I is embedded in the rotating body and is arranged coaxially therewith; a front end of the water supply pipe I is connected to and communicated with an inlet of the rotary joint, and a rear end thereof passes through the rear end cover and extends to the outside of the rear shell, the water supply pipe I is configured with a solenoid valve which is communicatively connected to the data analysis controller;
the water supply pipe II is located in the vertical groove, and one end of the water supply pipe II is connected to and communicated with an outlet of the rotary joint, the high-pressure nozzle is located outside the rotating body and is mounted at the other end of the water supply pipe II, the high-pressure nozzle and the water supply pipe II can rotate around the rotary joint;
the direction adjustment assembly comprises an electric telescopic rod and two articulated seats, the electric telescopic rod is located above the water supply pipe II, the water supply pipe II is connected to an inner wall of the cavity of the rotating body through the electric telescopic rod, the electric telescopic rod drives the high-pressure nozzle and the water supply pipe II to swing up and down.

5. The early warning and emergency device for a sudden stress change in surrounding rock according to claim 3, wherein the data analysis controller is embedded with FLAC 3D numerical simulation software and matlab data processing modules, and the stress monitoring units and the positioning module are communicatively connected to the data analysis controller, respectively;
the data analysis controller rapidly processes the electrical signals transmitted by the stress monitoring units to generate a cloud map of sudden stress changes in surrounding rock, achieving full tunnel coverage of the cloud map of sudden stress changes; in a case where a sudden stress change in surrounding rock occurs somewhere in the tunnel, a sudden stress change point can be instantly determined based on the cloud map of the sudden stress change in the tunnel and the positioning modul.

6. A method of using an early warning and emergency device for a sudden stress change in surrounding rock, characterized in that the early warning and emergency device for a sudden stress change in surrounding rock described in claim 1 is used, and the method of use comprising the following steps:
S1, determine sudden stress change early warning thresholds for surrounding rock based on the analysis of tunnel field monitoring data and laboratory experimental data, the early warning thresholds including an early warning threshold and an early warning threshold, and import the sudden stress change early warning thresholds into a data analysis controller, specifically, the surrounding rock refers to the coal-rock mass;
S2, determine a transport tunnel section that is greatly affected by mining stress and has a large number of workers, arrange a self-positioning temporary patrol robot in the transport tunnel section, determine installation points of early warning and emergency devices for a sudden stress change in surrounding rock on a rock wall of the transport tunnel section, drill holes at the installation points on the rock wall, and clean the inside of boreholes;
all the installation points are arranged in a square array on the rock wall. The horizontal distance between any two adjacent installation points is 3 m to 5 m, and the vertical distance between any two adjacent installation points is 1 m to 1.5 m;
S3, adjust the relative positions of the front shell and the rear shell so that the stress monitoring unit in the front shell corresponds to the stress monitoring unit in the rear shell, and apply anchoring glue on the outer walls of the front shell and the rear shell, avoiding the water guide grooves outside the rear shell;
afterwards, the early warning and emergency devices for a sudden stress change in surrounding rock are sent into the boreholes, the front shells and rear shells are fixed to the rock walls inside the boreholes with anchoring glue, and the ends of each water supply pipe I are connected to the high-pressure water supply device;
S4, number and zero each early warning and emergency device for a sudden stress change in surrounding rock, and establish communicative connection with an underground gateway;
the stress monitoring units are activated, a sudden stress change in the surrounding rock is monitored through the strain gauges and the ground sound sensor, and the sudden stress change signal is converted into an electrical signal and transmitted to the data analysis controller in real time;
the data analysis controller processes the received electrical signals in real time through the internally embedded FLAC 3D numerical simulation software and matlab data processing modules to generate a real-time cloud map of sudden stress changes of the entire tunnel;
S5, the data analysis controller compares and analyzes a sudden stress change value with the early warning thresholds in real time, and the wireless communication module transmits the comparison and analysis results to the underground gateway in real time;
in a case where the sudden stress change value is less than the early warning threshold 1, the high-pressure jet mechanism, the acoustic and optical early warning unit and the self-positioning temporary patrol robot will not respond;
in a case where the sudden stress change value is greater than or equal to the early warning threshold and less than the early warning threshold, the positioning module locates the sudden stress change point, the early warning and emergency device for a sudden stress change in surrounding rock near the sudden stress change point responds, and the high-pressure nozzle hydraulically perforates, depressurizes and softens the sudden stress change point; the wireless communication module sends sudden stress change point information and inspection information to a ground dispatching department through the underground gateway to pre-crack and depressurize the rock mass near the sudden stress change point, and meanwhile, the self-positioning temporary patrol robot responds to provide temporary support for the sudden stress change point;
in a case where the early warning threshold is less than or equal to the sudden stress change value, an acoustic and optical early warning device responds to remind nearby workers to evacuate quickly, the high-pressure nozzle continues to hydraulically perforate, depressurize and soften the sudden stress change point, and the wireless communication module sends the sudden stress change point information and rescue information to the ground dispatching department through the underground gateway.

7. The method of using an early warning and emergency device for a sudden stress change in surrounding rock according to claim 1, wherein the self-positioning temporary patrol robot comprises a frame, crawler walking mechanisms, an engine, a lifting bracket, a top plate, and a self-positioning control unit, there are two crawler walking mechanisms symmetrically arranged on both sides of the frame;
the engine is arranged on the frame to drive the crawler walking mechanisms to walk. The top plate is located above the frame, and the bottom of the top plate is connected to the top of the frame through the lifting bracket, the self-positioning control unit is arranged at the front of the frame to control the self-positioning temporary patrol robot to patrol the line.
